(19) United States
(12) Patent Application Publication
(10) Pub. No.: US 2004/0075628 A1
(43) Pub. Date: Apr. 22, 2004

(54) Double-side display device

(76) Inventors: Chih-Chung Chien, Taichung City (TW); Yen-Hua Chen, Taichung Hsien (TW); Yung-Chou Chan, Changhua Hsien (TW); Shi-Fang Hou, Tainan City (TW)

Correspondence Address: BIRCH STEWART KOLASCH & BIRCH, PO BOX 747, FALLS CHURCH, VA, 22040-0747, US

(21) Appl. No.: 10/274,265

(22) Filed: Oct. 21, 2002

(51) Int. Cl. G09G 3/32

(52) U.S. Cl. 345/82

(57) ABSTRACT

A double-side display device mainly employs the advantage of the transparent cathode that enables an OLED display device to illuminate on two sides concurrently or adopts a novel design for a conventional single side display OLED such that only one driving module is needed to output signals to display the same picture on the positive (anode) side and the negative (cathode) side concurrently. While the displayed pictures and characters are inverse in terms of the left and the right directions, they may be controlled and rectified through software. Thus on the same OLED display panel, two large display zones may be designed and setup to display on the positive (anode) side and the negative (cathode) side.

### FIELD OF THE INVENTION

The present invention relates to a double-side display device and particularly a display device that employs a single driving module to display on two sides to conform to functional requirements of handset panels and to enhance production yield and assembly efficiency, and reduce the cost of modules to improve product competitiveness.

### BACKGROUND OF THE INVENTION

The growing popularity of handsets and continuous improving of communication quality enable the handsets to evolve from merely displaying numerals in the past to dynamic pictures now. Demands for high quality display devices increase constantly. When a handset is in use, battery power consumption is one of the critical factors. At present the display on the handsets mostly has changed to dual display screens from a single display screen in the past. There is a main screen with a bigger display screen for displaying multifunctional receiving and transmitting functions. A smaller screen is provided to display signals in normal conditions that include signals, incoming call, time, etc. In the standby mode, only the signal screen is displaying, thus power consumption can be reduced. However the dual display screens generally require two driving modules to control independently. As a result, more driving ICs are needed and production cost is higher.

### SUMMARY OF THE INVENTION

The primary object of the invention is to resolve the aforesaid disadvantages. The invention employs the self illumination principle of Organic Light Emitting Diode (OLED) and adopts the design of transparent double-side electrodes to enable a single driving module to actuate one panel to display on two sides.

Another object of the invention is to use a Flexible Printed Circuit (FPC) to connect the Scan line and Data line of one single-side display OLED to another single-side OLED so that a single driving module can be used to actuate two panels.

In order to achieve the foregoing objects, the double-side display device of the invention consists of one or two OLED panels and one or two signal transmission units connecting to the OLED panels. One of the signal transmission units has a driving unit. When the driving unit outputs a driving signal, one or two OLED panels form a main display zone and a signal display zone to display in a dual-side fashion.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a single OLED panel for double-side display according to the invention, showing a positive side and a reverse side.

FIG. 2 is a schematic side view of FIG. 1.

FIG. 3 is a schematic view of two OLED panels for double-side display according to the invention, showing a positive side and a reverse side.

FIG. 4 is a schematic side view of FIG. 3.

FIG. 5 is a schematic side view of two OLED panels for double-side display according to another embodiment of the invention.

### DESCRIPTION OF THE PREFERRED EMBODIMENTS

The double-side display screen device of the invention mainly employs the self illumination property of OLED and transparent electrodes on two sides to achieve double-side display through a single driving module so that manufacturing of the double-side display OLED panel is same as the single-side display OLED panel, and only one driving unit is required, thus manufacturing cost is greatly reduced and production time also decreases.

The general OLED is a self illuminating device which has a transparent ITO (Indium Tin Oxide) electrode as the anode and an opaque metallic electrode as the cathode. Thus when the OLED display device illuminates, only the anode displays in a single side fashion.

The invention employs a transparent cathode that enables the OLED display device to illuminate two sides concurrently, or employs a conventional OLED of a single-side display but with a novel design and construction so that in both cases mentioned above only one driving module is needed to output signals to display the same picture on the positive side (anode) and the negative side (cathode). The pictures and characters displayed on the negative side and the positive side are inverse in terms of left and right directions. This can be controlled and rectified through software. Hence two large display zones may be designed and setup on the same OLED display panel. One display zone is on the positive side (anode) and another display zone is on the negative side (cathode).

In addition, if two general OLED panels are used (to display only through the anode), they may be connected by means of a FPC (Flexible Printed Circuit). The Scan line and Data line of one OLED panel are connected to another OLED panel, then one single driving IC can actuate the two display panels.

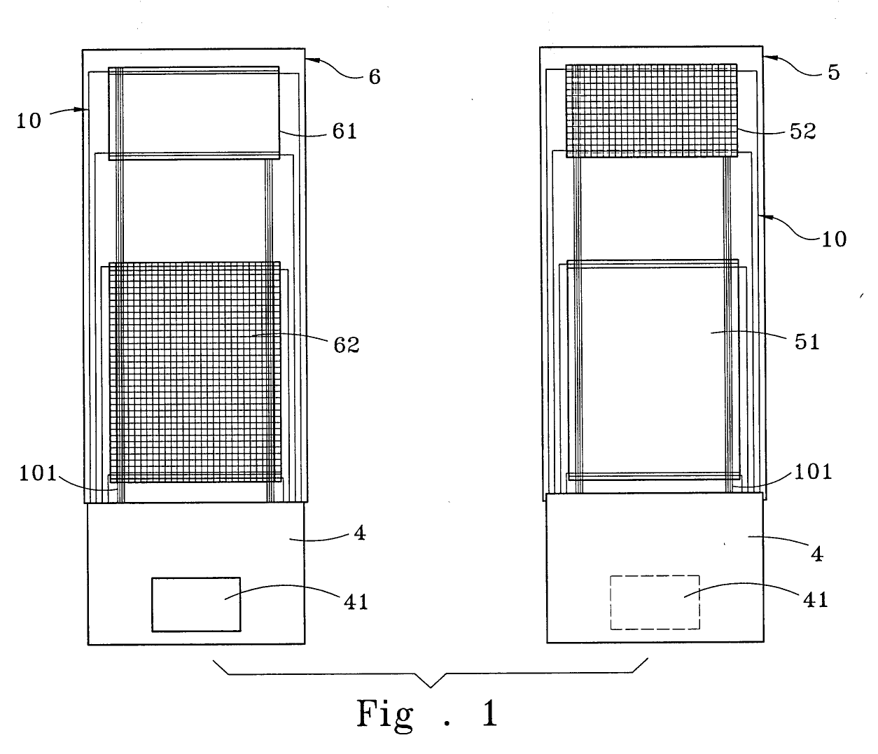

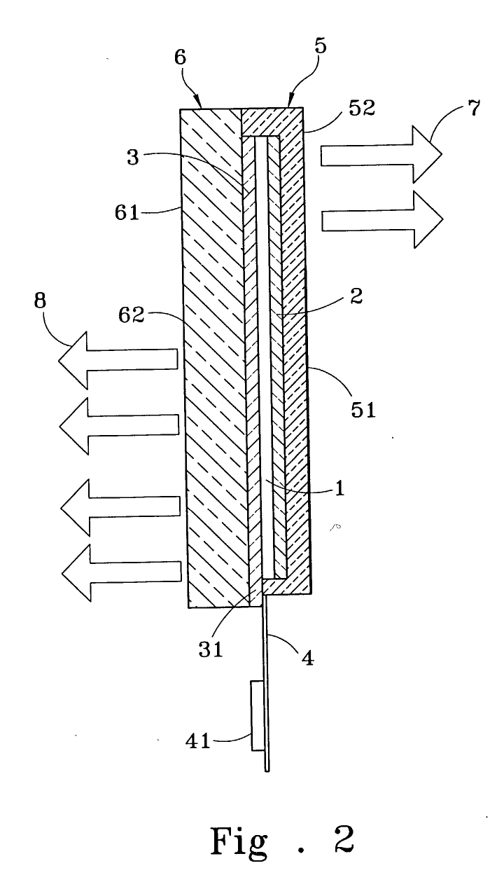

Refer to FIGS. 1 and 2 for a double-side display device of the invention that uses one single OLED panel. The double-side display device includes at least one organic luminous layer 1, a transparent cathode layer 2 located on one side of the organic luminous layer 1, and a transparent anode layer 3 located on another side of the organic luminous layer 1. The transparent anode layer 3 has a greater length than the transparent cathode layer 2. The extra length forms a connection zone 31 for connecting to a signal transmission unit 4.

In addition, the transparent cathode layer 2 and the transparent anode layer 3 are encased by a transparent cap 5 and a transparent lid 6 made from glass or a plastic substrate. The surfaces of the cap 5 and the lid 6 have respectively a reflective film 51 or a light absorption layer 61 disposed thereon at selected locations. The areas of the cap 5 and the lid 6 not covered by the reflective film 51 or the light absorption layer 61 form a main display zone 62 and a signal display zone 52. When the organic luminous layer 1 illuminates, light sources 7 and 8 project through the transparent cathode layer 2 and the transparent anode layer 3, and pass through the uncovered main display zone 62 and the signal display zone 52 of the cap 5 and the lid 6 to display in a double-side fashion.

The signal transmission unit 4 mentioned above may include a single-side or a double-side flexible FPC, membrane circuit, flat cable or a general printed circuit board (PCB) with a driving unit 41 located thereon. The signal transmission unit 4 connects to the transparent anode layer 3 through a transparent cathode circuit 10 and a transparent anode circuit 101. When the driving unit 41 outputs a driving signal, the organic luminous layer 1 illuminates. The light sources 7 and 8 pass through the transparent cathode layer 2 and the transparent anode layer 3, and the main display zone 62 and the signal display zone 52 of the cap 5 and the lid 6 that are not covered to display in a double-side fashion.

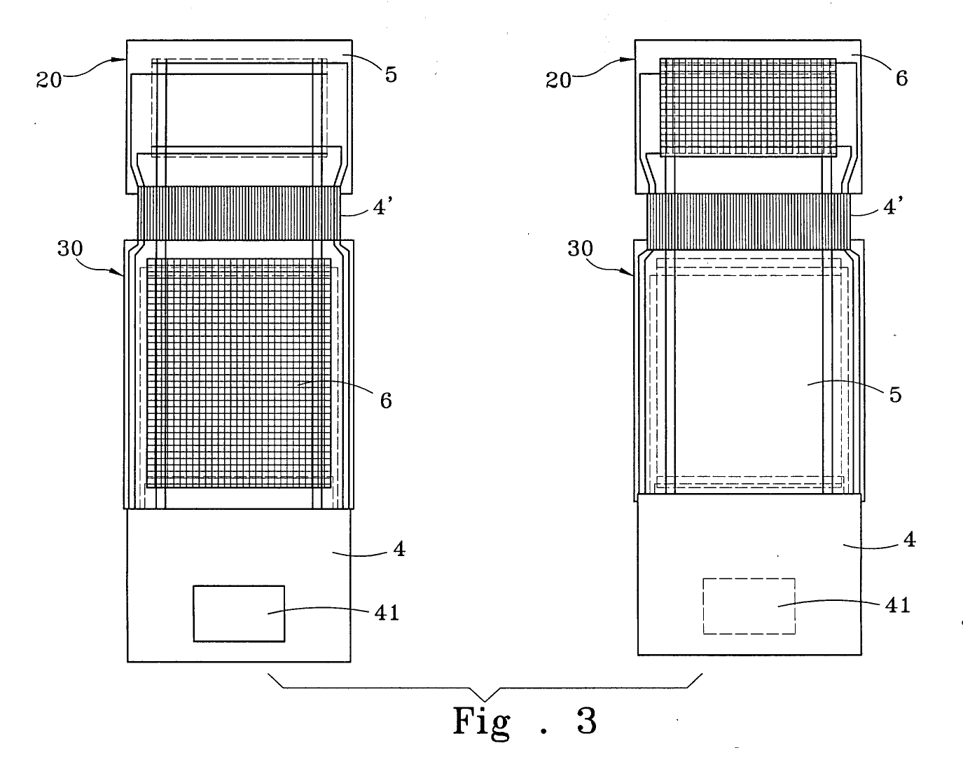

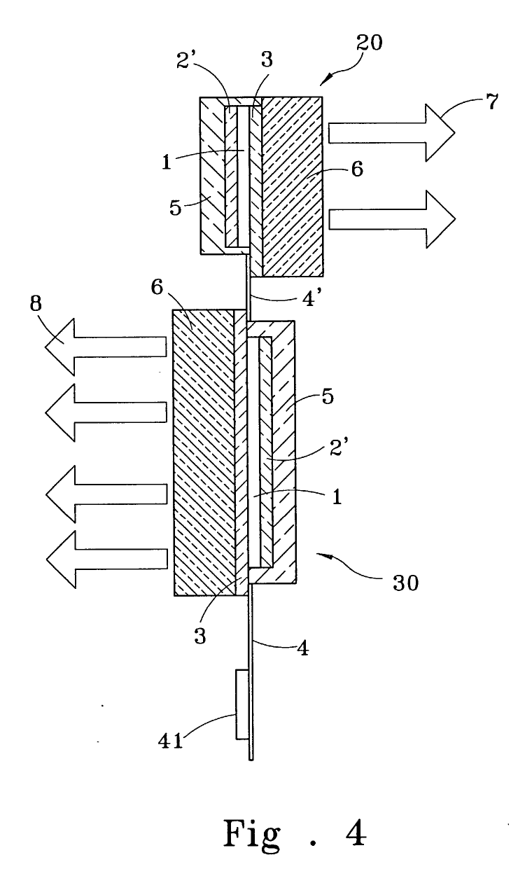

Refer to FIGS. 3 and 4 for a double-side display device of the invention that uses two OLED panels. The transparent cathode layer 2 is changed to a metallic cathode layer 2′. Of the two OLED panels, one OLED panel 20 is for the signal display zone and another OLED panel 30 is for the main display zone. The two panels are connected by a signal transmission unit 4′. When the driving unit 41 of another signal transmission unit 4 generates a driving signal output, the two OLED panels 20 and 30 generate dual displays.

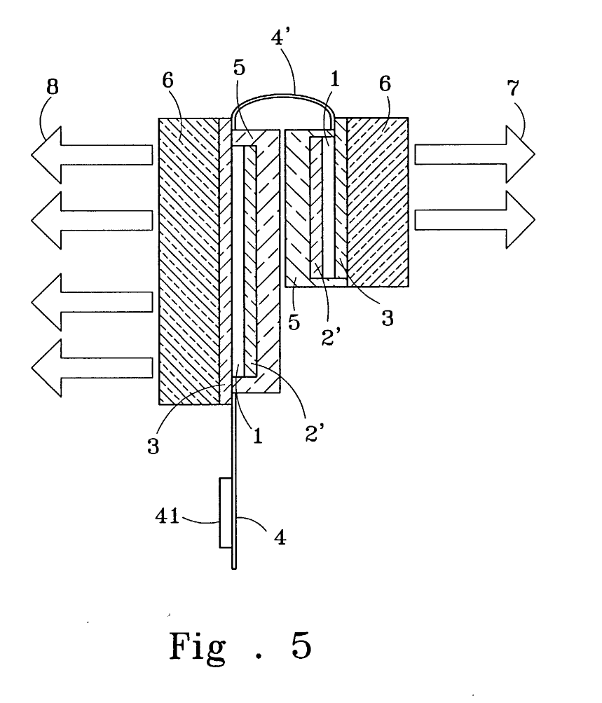

Refer to FIG. 5 for another embodiment of the double-side display device of the invention that uses two OLED panels. It is substantially constructed like the one shown in FIGS. 3 and 4. The difference is that the signal transmission unit 4′ is bent to enable the two OLED panels 20 and 30 to form a front side and a rear side relationship. When the driving unit 41 of another signal transmission unit 4 generates a driving signal output, the two OLED panels 20 and 30 generate dual displays in a front side and a rear side fashion.

Furthermore, the cost of the driving IC generally represents about 20% to 30% of the total cost of the OLED module. As the invention can reduce the number of driving IC needed, total product cost is lower and manufacturing processes can be reduced, and the structural design is simpler than conventional dual-module approach.

What is claimed is:

1. A double-side display device using a single OLED panel, comprising:
an organic light emitting diode; and
a signal transmission unit connected to the organic light emitting diode including a driving unit which outputs a driving signal to allow the organic light emitting diode to form a main display zone and a signal display zone to display in a double-side fashion.

2. The double-side display device of claim 1, wherein the signal transmission unit is selected from the group consisting of a flexible printed circuit, a membrane circuit, a flat cable or a general printed circuit board.

3. The double-side display device of claim 2, wherein the signal transmission unit is selectively single-side or double-side.

4. The double-side display device of claim 1, wherein the organic light emitting diode includes at least:
an organic luminous layer;
a transparent cathode layer located on one side of the organic luminous layer;
a transparent anode layer located on another side of the organic luminous layer having a greater length than the transparent cathode layer with an extra length to form a connection zone; and
a cap and a lid encasing the transparent cathode layer and the transparent anode layer to form a reflective film on selected locations thereof such that areas of the cap and the lid not covered by the reflective film form a main display zone and a signal display zone.
